(19) United States
(12) Patent Application Publication
(10) Pub. No.: US 2007/0133774 A1
(43) Pub. Date: Jun. 14, 2007

(54) Teleconference system, teleconference method and teleconference terminal apparatus

(75) Inventor: Jun Fujimoto, Tokyo (JP)

Correspondence Address: SNIDER & ASSOCIATES, P. O. BOX 27613, WASHINGTON, DC, 20038-7613, US

(73) Assignee: Aruze Corp., Tokyo (JP)

(21) Appl. No.: 11/541,722

(22) Filed: Oct. 3, 2006

(30) Foreign Application Priority Data
Oct. 5, 2005 (JP) 2005-291924

(51) Int. Cl. H04M 3/42

(52) U.S. Cl. 379/202.01

(57) ABSTRACT

A teleconference system of the present invention has: a plurality of teleconference terminal apparatuses which conduct a teleconference with display of images and outputting of voices by transmitting and receiving image signals and voice signals; a communications network which connects the teleconference terminal apparatuses so that data can be communicated; and mode setting means for setting arbitrarily any apparatus of the teleconference terminal apparatuses to a chairperson terminal mode for managing a teleconference. Each of the teleconference terminal apparatuses has transmission control means for transmitting the image signals and voice signals only when permitted by an apparatus which is set to the chairperson terminal mode.

### RELATED APPLICATIONS

This application claims the priority of Japanese Patent Application No. 2005-291924 filed on Oct. 5, 2005, which is incorporated herein by reference.

### BACKGROUND OF THE INVENTION

1. Field of the Invention

The present invention relates to a teleconference terminal system, teleconference method and teleconference terminal apparatus for conducting a teleconference using a communications lines.

2. Description of the Prior Art

Conventionally, as a teleconference system for carrying out a teleconference among a plurality of points, there has been proposed a configuration comprising a plurality of mobile units capable of transmitting voice signals and image signals, a parent station connected to these mobile units via a communications network, an image transmission device provided in the parent station and capable of identifying a voice signal and switching between motion and still images, and a plurality of monitors connected to the image transmission device and capable of displaying images of all the mobile units.

In the above configuration, still images of conditions of all of the mobile units are displayed on the monitors. Then, image signals obtained by each mobile unit recording a motion image are transmitted along with voice signals to the image transmission device of the parent station, and a mobile unit in-use is identified by the image transmission device on the basis of the voice signals from each mobile unit, whereby only an image projected on the monitor corresponding to the mobile unit in-use is switched from a still to a motion image. Accordingly, still images of the conditions of all of the mobile units can be monitored and a motion image of the mobile unit in-use can be displayed on the monitor without selecting operation particularly on the parent station side (Japanese Unexamined Patent Publication No. H5-153585).

However, in the teleconference system described in the above publication document, since all of the mobile units transmit image signals of motion images to the parent station regardless of whether the mobile units are in use, the traffic of the communications network between the mobile units and the parent station easily expands excessively, thus the problem is that the amount of data of the image signals should be reduced although the quality of image display in the motion and still images deteriorates.

### SUMMARY OF THE INVENTION

An object of the present invention therefore is to provide a teleconference system, teleconference method and teleconference terminal apparatus, capable of checking contents of particular importance, through big screen and good image quality and the like, while preventing the traffic in the communications network from expanding.

A teleconference system according to the present invention, comprising:

a plurality of teleconference terminal apparatuses which conduct a teleconference with display of images and outputting of voices by transmitting and receiving image signals and voice signals; a communications network which connects the teleconference terminal apparatuses to communicate data; and chairperson terminal mode setting means for arbitrarily setting any apparatus of the teleconference terminal apparatuses to a chairperson terminal mode for managing a teleconference;

wherein each of the teleconference terminal apparatuses has transmission control means for transmitting the image signals and voice signals only when permitted by an apparatus which is set to the chairperson terminal mode.

Further in the teleconference system according to the present invention, each of the teleconference terminal apparatuses comprises: an image-capturing device which generates the image signals by capturing an image; an image output processing section which converts the image signal to a signal mode corresponding to the communications network and outputs the converted signal; a microphone which performs detection of a voice along with the image capturing, and thereby generates a voice signal corresponding to the level of the voice; a voice output processing section which converts the voice signal to a signal mode corresponding to the communications network and outputs the converted signal; an image output processing control section which increases or reduces the amount of data of the image signal outputted from the image output processing section, on the basis of the level of the voice signal; and a display which displays information related to the image signal, on a screen.

Moreover, in the teleconference system according to the present invention, in the display, a chairperson screen, which is displayed in a chairperson terminal mode, displays at least a participant (attendance) display section, a presentation end button for ending a presentation of the chairperson and other participant, a presentation request button for forcibly causing the chairperson to make a presentation, and a presentation permitting button for permitting a participant, who waits to make a presentation, to make a presentation.

Further, in the teleconference system according to the present invention, the image output processing section comprises: an image signal transmission frame memory; an image codec section which compresses the image signal; and, between the image signal transmission frame memory and the image codec section, image signal transmission switching means for switching between permission of passage and prohibition of passage of the image signal in response to a switch signal from transmission signal switching control means, and

the voice output processing section which comprises: a voice signal transmission frame memory; a voice codec section which compresses the voice signal; and, between the voice signal transmission frame memory and the video codec section, a voice signal transmission switching means for switching between permission of passage and prohibition of passage of the voice signal in response to a switch signal from the transmission signal switching control means.

Further, a teleconference terminal apparatus for conducting a teleconference through display of images and outputting of voices by transmitting and receiving image signals and voice signals via a communications network according to the present invention, comprising: mode setting means for setting the teleconference terminal apparatus to either a chairperson terminal mode or a participant terminal mode; transmission switching means for switching between a transmission of the image signals and the voice signals and a stoppage of transmission of the image signals and the voice signals; presentation requesting means for requesting the teleconference terminal apparatus, which is set to the chairperson terminal mode, to make a presentation by transmitting the image signals and the voice signals; presentation request recognition means for recognizing the apparatus in the participant terminal mode requesting the presentation; and switching control means for controlling the transmission switching means of the apparatus in the participant terminal mode, the apparatus being recognized by the presentation request recognition means, so as to allow the apparatus to make a presentation.

Moreover the teleconference terminal apparatus according to the present invention, comprising: an image-capturing device which generates the image signals by capturing an image; an image output processing section which converts the image signal to a signal mode corresponding to the communications network and outputs the converted signal; a microphone which performs detection of a voice along with the image capturing, and thereby generates a voice signal corresponding to the level of the voice; a voice output processing section which converts the voice signal to a signal mode corresponding to the communications network and outputs the converted signal; an image output processing control section which increases or reduces the amount of data of the image signal outputted from the image output processing section, on the basis of the level of the voice signal; and a display which displays information related to the image signal, on a screen.

Further, in the teleconference terminal apparatus according to the present invention, the image output processing section comprises: an image signal transmission frame memory; an image codec section which compresses the image signal; and, between the image signal transmission frame memory and the image codec section, image signal transmission switching means, and

the voice output processing section which comprises: a voice signal transmission frame memory; a voice codec section which compresses the voice signal; and, between the voice signal transmission frame memory and the voice codec section, the voice signal transmission switching means.

Still further, in the teleconference communication method for conducting a teleconference with display of images and outputting of voices by a plurality of teleconference terminal apparatuses transmitting and receiving image signals and voice signals via a communications network according to the present invention, one of the teleconference terminal apparatuses is set to a chairperson terminal mode, and only the teleconference terminal apparatus, which has permission from the apparatus in the chairperson terminal mode, can transmit the image signals and voice signals.

### BRIEF DESCRIPTION OF THE DRAWINGS

FIG. 1 is a schematic diagram of the teleconference system according to an embodiment;

FIG. 2 is an explanatory diagram of a conference information management table;

FIG. 3 is an explanatory diagram of a display screen of a teleconference terminal apparatus;

FIG. 4 is an explanatory diagram of the display screen of the teleconference terminal apparatus;

FIG. 5 is an explanatory diagram of the display screen of the teleconference terminal apparatus;

FIG. 6 is an explanatory diagram of the display screen of the teleconference terminal apparatus;

FIG. 7 is an explanatory diagram of the display screen of the teleconference terminal apparatus;

FIG. 8 is a flowchart of an initial setting routine;

FIG. 9 is a flowchart of an information output processing routine;

FIG. 10 is a flowchart of a participant procedure processing routine; and

FIG. 11 is a flowchart of a chairperson procedure processing routine.

### DESCRIPTION OF THE PREFERRED EMBODIMENTS

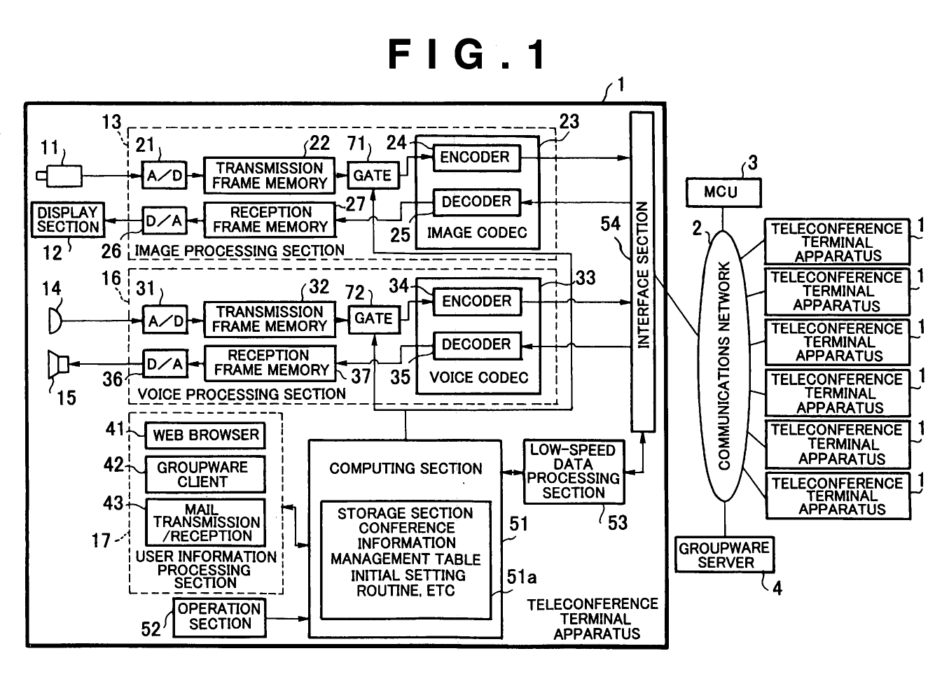

Embodiments of the present invention are described hereinafter with reference to FIG. 1 through FIG. 11.

(Teleconference System)

The teleconference system according to the present embodiment has, as shown in FIG. 1, a communications network 2 such as a public line and private line, a teleconference terminal apparatus 1, which is described later, for carrying out a teleconference by transmitting and receiving an image signal and a voice signal via the communications network 2, a MCU 3 (Multipoint Control Unit) which controls multipoint connections among the teleconference terminal apparatuses 1 within the communications network 2, and a groupware server 4 which manages the teleconference terminal apparatuses 1 for users and the like. It should be noted that the teleconference terminal apparatus 1, MCU 3, and groupware server 4 are configured from commercially available workstations, personal computers (PC), network connection devices, and the like. The functions contained in the teleconference terminal apparatuses 1 and the like are realized by the hardware such as the workstations, PCs, network connection devices and the like, and software processing using these hardware resources.

The MCU 3 is configured such as to combine/distribute videos/voices by simultaneously connecting three or more points to switch or mix the videos and voices, and thereby realizes a teleconference. Specifically, the MCU 3 is configured so as to be able to perform setting of used resources for each conference, and setting of a communication rate, audio rate, video rate, video session, the number of split screens, video protocol, participant setting information consisting of the type of the interface type, connection type, IP address, telephone number, signal port, the number of line channels, and voice level (volume) of a participant, the time and date for starting to reserve a conference, and duration time information.

Furthermore, the groupware server 4 is connected to the teleconference terminal apparatuses 1 and other terminal apparatus having a groupware client function, and has a database required for performing collaboration work in a group of users by using these teleconference terminal apparatuses 1, and a database server which manages the database. Moreover, the groupware server 4 has a conference reservation function for performing notification of a conference via an email to a participant in the conference, a schedule management function for managing a schedule, and other functions.

(Teleconference Terminal Apparatus 1)

The teleconference terminal apparatus 1, which is used in the teleconference system configured as described above, has an image-capturing device 11 which generates an image signal by capturing an image of a subject such as a person or the like, a display device 12 such as a liquid crystal display device which displays the image signal on a screen, and an image processing section 13 which is connected to the image-capturing device 11 and the display device 12.

The image processing section 13 has an image transmission conversion function which converts an image signal sent from the image-capturing device 11 to a signal mode corresponding to the communications network 2, and an image reception conversion function which converts an image signal sent from the communications network 2 to a signal mode corresponding to the display device 12. The image transmission conversion function is realized by an A/D converter 21 which converts the image signal sent from the image-capturing device 11 to a digital signal, a transmission frame memory 22 which stores the image signal digitalized by the A/D converter 21, an encoder section 24 of an image codec section 23, and the like. Moreover, the image reception conversion function is realized by a decoder section 25 of the image codec section 23, a reception frame memory 27 which stores an image signal outputted from the decoder section 25, a D/A converter 26 which converts the image signal to an analog signal, and the like.

The encoder section 24 of the image codec section 23 comprises an image codec which converts uncompressed image data to a form of a compressed file. Further, the decoder section 25 of the image codec section 23 comprises an image codec which returns the compressed file of the image data to an uncompressed file. It should be noted that the image codec does not perform lossless compression in which a compressed file can be completely returned to the original file when the compressed file is decoded (unpacked), but performs lossy compression for processing the file so that the quality of the original file is not damaged.

A front stage of the encoder section 24 is provided with a gate 71 capable of stopping transmission of image signals. Specifically, the gate 71 is provided between the encoder section 24 and the transmission frame memory 22. The gate 71 is capable of switching between permission of passage and prohibition of passage of an image signal, which is outputted from the transmission frame memory 22, through the encoder section 24, and this switching is controlled by a transmission permission signal sent from a computing section 51 described hereinafter. In other words, the gate 71 permits a passage of an image signal when the transmission permission signal is inputted from the computing section 51, or prohibits a passage of an image signal when the transmission permission signal is not inputted from the computing section 51.

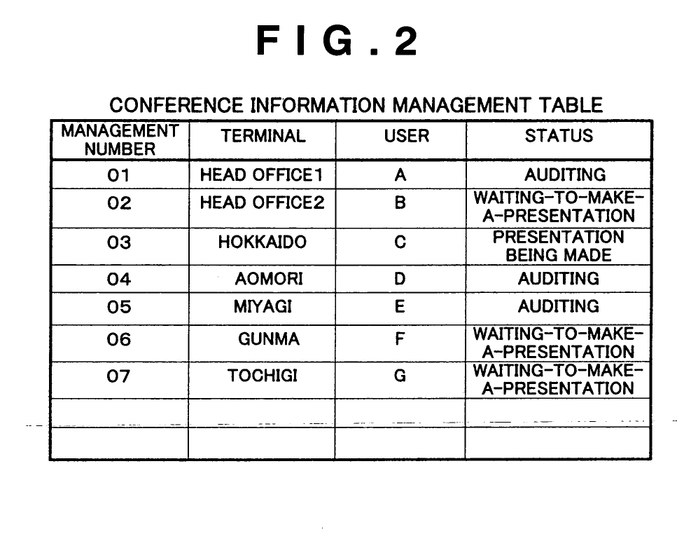

Moreover, the teleconference terminal apparatus 1 further comprises, as shown in FIG. 2 as well, a microphone 14 which performs detection of a voice along with image capturing performed by the image-capturing device 11, and thereby generates a voice signal corresponding to the level of the voice, a speaker 15 which outputs the voice signal as a voice, and a voice processing section 16 which is connected to the microphone 14 and the speaker 15.

The voice processing section 16 has a voice transmission conversion function which converts a voice signal sent from the microphone 14 to a signal mode corresponding to the communications network 2, and a voice reception conversion function which converts a voice signal sent from the communications network 2 to a signal mode corresponding to the speaker 15. The voice transmission conversion function is realized by an A/D converter 31 which converts the voice signal sent from the microphone 14 to a digital signal, a transmission frame memory 32 which stores the voice signal digitalized by the A/D converter 31, an encoder section 34 of a voice codec section 33, and the like. Further, the voice reception conversion function is realized by a decoder section 35 of the voice codec section 33, a reception frame memory 37 which stores a voice signal outputted from the decoder section 35, a D/A converter 36 which converts the voice signal to an analog signal, and the like.

As with the image codec section 23, the voice codec section 33 has a voice codec which converts uncompressed data to a form of a compressed file in the encoder section 34 and decodes (unpacks) the compressed file to an uncompressed file in the decoder section 35.

A front stage of the encoder section 34 is provided with a gate 72 capable of stopping transmission of image signals. Specifically, the gate 72 is provided between the encoder section 34 and the transmission frame memory 32. The gate 72 is capable of switching between permission of passage and prohibition of passage of a voice signal, which is outputted from the transmission frame memory 32, through the encoder section 34, and this switching is controlled by a transmission permission signal sent from the computing section 51 described hereinafter. In other words, as in the case of the gate 71 of the image processing section 13, the gate 72 permits a passage of a voice signal when the transmission permission signal is inputted from the computing section 51, or prohibits a passage of a voice signal when the transmission permission signal is not inputted from the computing section 51.

The image processing section 13 and the voice processing section 16 are connected to an interface section 54. The interface section 54 is connected to the communications network 2. The teleconference terminal apparatus 1 can perform data communication with other teleconference terminal apparatus 1, MCU 3, or groupware server 4 via the communications network 2.

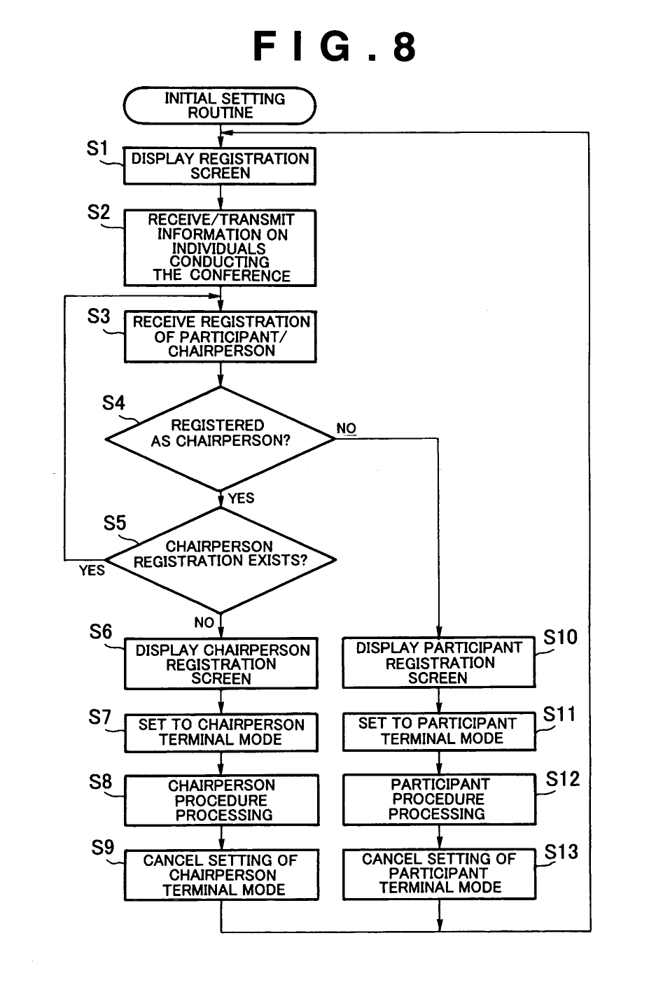

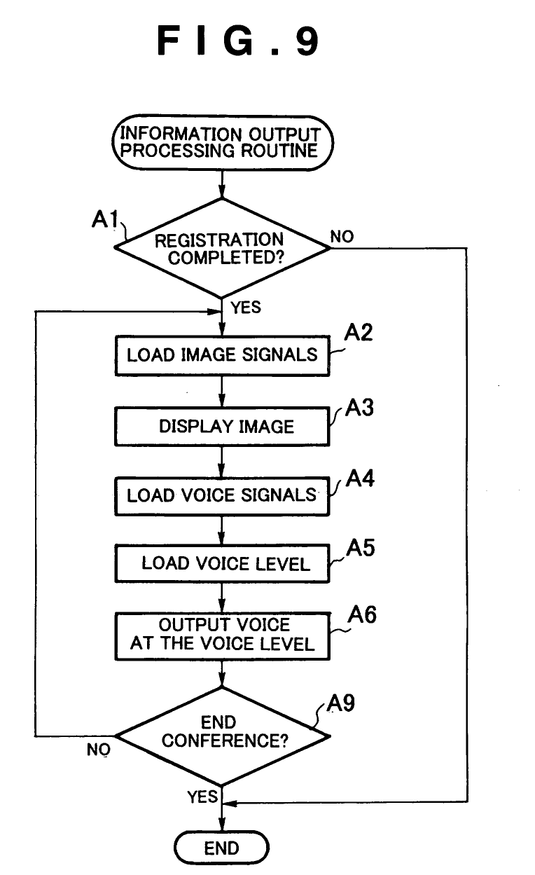

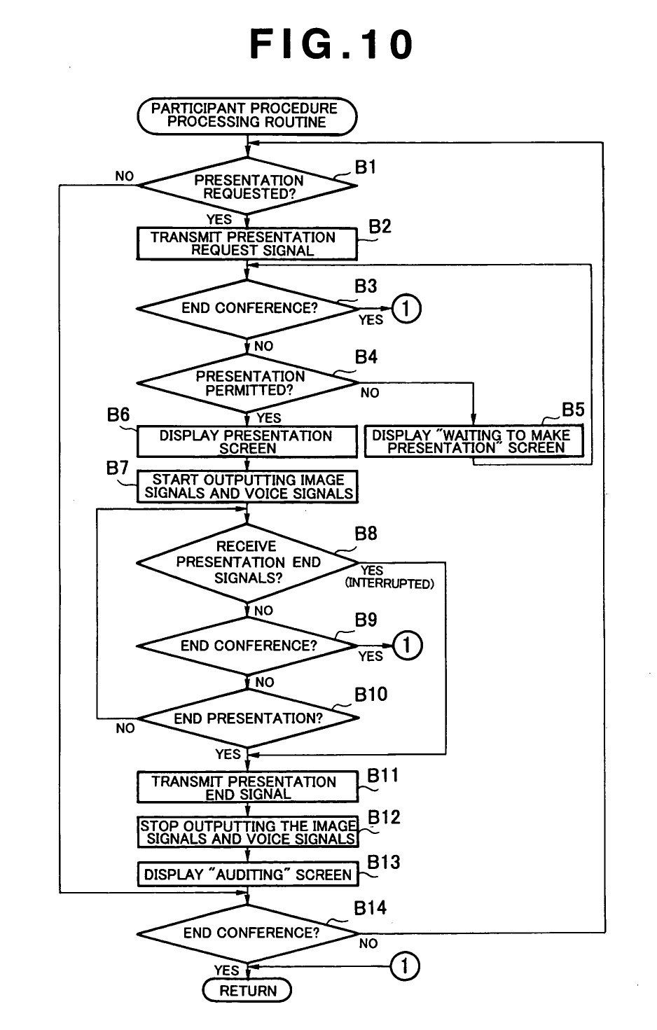

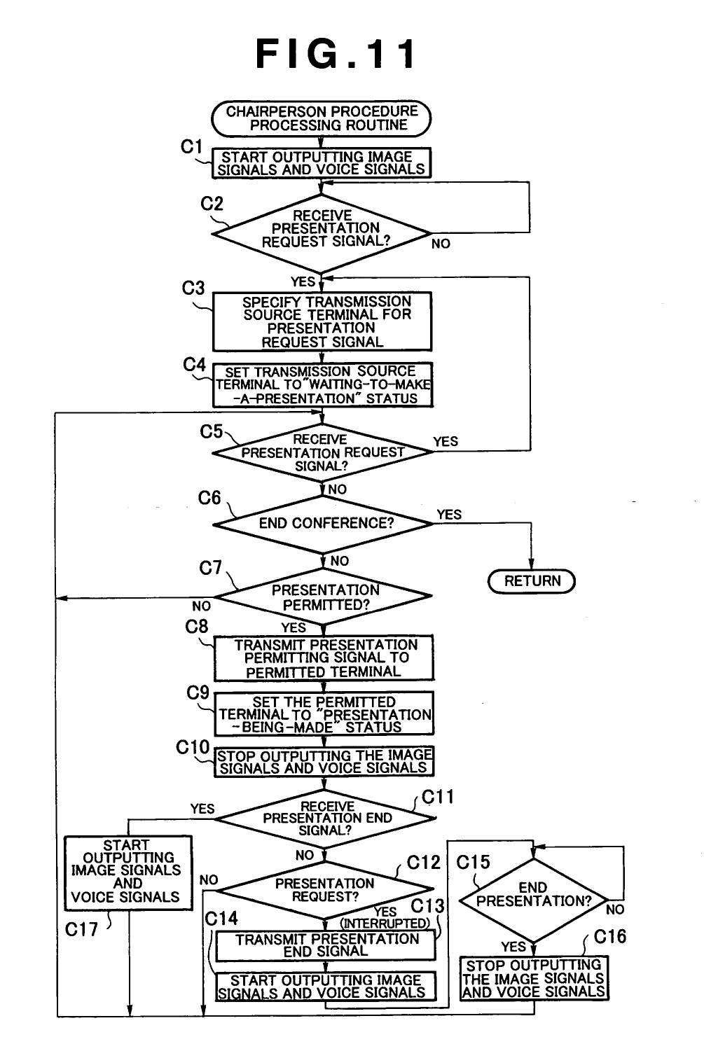

The interface section 54 is connected to the computing section 51 via a low-speed data processing section 53 which processes control data, information on the individuals conducting the conference, and the like. The computing section 51 comprises an unshown CPU (central processing unit), a storage section 51a, and the like, and controls an operation of the teleconference terminal apparatus 1. Specifically, the storage section 51a of the computing section 51 stores various data items for the conference information management table shown in FIG. 2, and various programs for the initial setting routine shown in FIG. 8, the information output processing routine shown in FIG. 9, the participant procedure processing routine shown in FIG. 10, and the chairperson procedure processing routine shown in FIG. 11, and the like.

The initial setting routine causes the computer (computing section 51) to function as mode setting means for setting to either a chairperson terminal mode or a participant terminal mode. Here, “chairperson terminal mode” is a mode for causing the teleconference terminal apparatus 1 to function as a terminal apparatus for a chairperson managing the teleconference by controlling an operation of each teleconference terminal apparatus 1. “Participant terminal mode” is a mode for causing the teleconference terminal apparatus 1 to function as a terminal apparatus for a participant, which has transmission control means for transmitting image signals and voice signals, only when permitted by the apparatus 1 which is set to the chairperson terminal mode.

The information output processing routine shown in FIG. 9 causes the computer (computing section 51) to function as means for loading image signals and voice signals, which are inputted via the communications network 2, to display images and output voices, and means for loading the information on the individuals conducting the conference, which is inputted via the communications network 2, to display screen images. Here, “information on the individuals conducting the conference” means the data of the locations of the teleconference terminal apparatuses 1, the data of users of the teleconference terminal apparatuses 1, who participate in the conference, and the data related to a status of the participation in the conference, and the like.

The participant procedure processing routine shown in FIG. 10 is a program which is executed when the teleconference terminal apparatus 1 is activated as the participant terminal apparatus in the “participant terminal mode”, and causes the computer (computing section 51) to function as the transmission control means for transmitting image signals and voice signals, only when permitted by the apparatus 1 which is set to the chairperson terminal mode. Specifically, the computer (computing section 51) is caused to function as transmission switching means capable of switching between a transmission of image signals and voice signals and a stoppage of transmission of image signals and voice signals, by controlling output of the transmission permission signal to the gate 71 or 72, and presentation requesting means for requesting the teleconference terminal apparatus 1 (chairperson terminal apparatus), which is set to the chairperson terminal mode, to allow a presentation to be made by transmitting image signals and voice signals during a teleconference.

The chairperson procedure processing routine shown in FIG. 11 is a program which is executed when the teleconference terminal apparatus 1 is activated as the chairperson terminal apparatus in the “chairperson terminal mode”. The chairperson procedure processing routine causes the computer (computing section 51) to function as: presentation request recognition means for recognizing the teleconference terminal apparatus 1 (participant terminal apparatus) in the participant terminal mode, which requests for permission to make a presentation; and switching control means for controlling the transmission switching means of the teleconference terminal apparatus 1 (participant terminal apparatus) in the participant terminal mode, the apparatus being recognized by the presentation request recognition means, so as to allow this apparatus 1 to make a presentation. It should be noted that the specific operation of each of the above-mentioned routines is described hereinafter.

An operation section 52 such as a keyboard and mouse, and a user information processing section 17 are connected to the computing section 51. The user information processing section 17 comprises a web browser function 41, a groupware client function 42, mail transmission/reception function 43, and the like. Accordingly, the teleconference terminal apparatus 1 can view a web page on the Internet by means of the web browser function 41, and also can transmit or receive mails to and from other teleconference terminal apparatuses 1 or the like by means of the mail transmission/reception function 43. Furthermore, the teleconference terminal apparatus 1 can use the groupware client function 42 to perform a collaboration work within a group of users in conjunction with other teleconference terminal apparatus 1 having the groupware client function, via the groupware server 4. For example, an email can be transmitted to each teleconference terminal apparatus 1 or other terminal apparatuses via the groupware server 4 to notify of a teleconference and to reserve the teleconference, or detailed preparation associated with the teleconference can be performed using the web browser function 41.

(Conference Information Management Table)

The conference information management table, which is stored in the storage section 51a of the computing section 51 along with the abovementioned programs, has a management number region, a terminal region, a user region, and a status region, as shown in FIG. 2. Each of the management number region, terminal region, and user region is set as a data region which is used in either the participant terminal mode or the chairperson terminal mode, and a data content of each region is displayed on the screen. On the other hand, the status region is set as a data region which is used when the teleconference terminal apparatus 1 is in the chairperson terminal mode, and a data content thereof is displayed on the screen, along with the data content of each of the abovementioned regions.

The management number region is a region for storing number data which is applied sequentially to the teleconference terminal apparatuses 1 used in a teleconference of this time. If, for example, “07” is the final number data, it means that seven teleconference terminal apparatuses 1 are used in the teleconference of this time. The terminal region is a region for storing the location data showing the locations of the teleconference terminal apparatuses 1. If, for example, the data shows “Aomori”, it means that the teleconference terminal apparatus 1 is set in Aomori. The user region is a region for storing name data showing the name of a user of the teleconference terminal apparatus 1. The status region is a region for storing status data showing a participation status for the teleconference. There are three types of the status data: “auditing” which indicates a status in which a participant hears a presentation in the conference; “waiting to make a presentation” which indicates a status in which a participant requests for permission to make a presentation; and “presentation being made” which indicates that a participant is making a presentation.

It should be noted that inputting of data into the management number region, terminal region and user region may be performed at each teleconference terminal apparatus 1 or may be performed collectively in the apparatus 1 in the chairperson terminal mode. When inputting data collectively, it is preferred to provide the apparatus 1 with a function of previously setting prospective participants in the conference and the date and time of the conference to each of the teleconference terminal apparatuses 1 used in the conference through the apparatus 1, which is set to the chairperson terminal mode, and of starting to automatically activate each of the teleconference terminal apparatuses 1 when the date and time for the conference has come. Further, it is preferred to provide a conference informing function for informing the prospective participants of the conference by sending mails or performing screen display from each of the teleconference terminal apparatuses 1.

(Screen Display of Teleconference Terminal Apparatus 1)

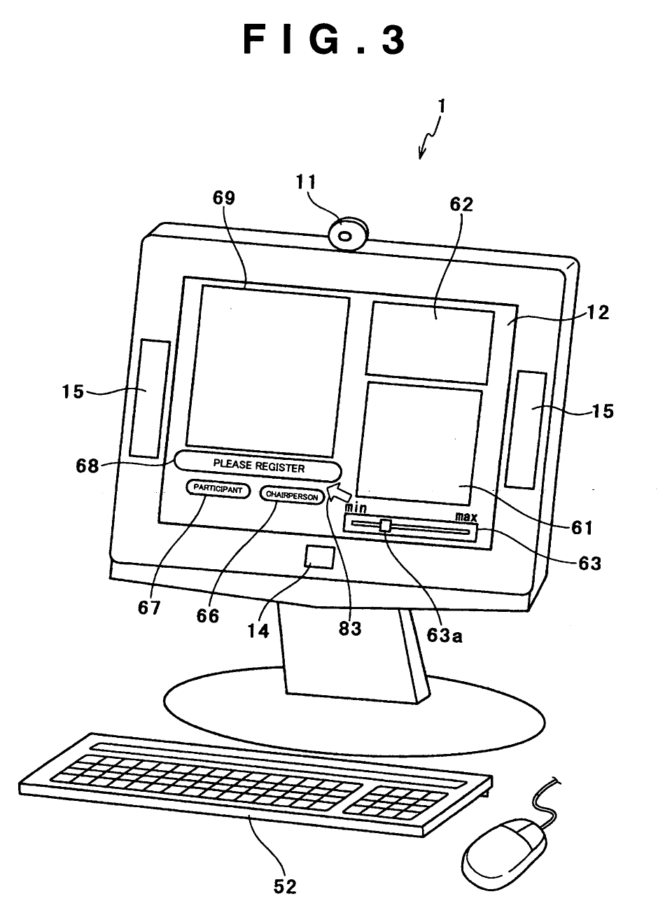

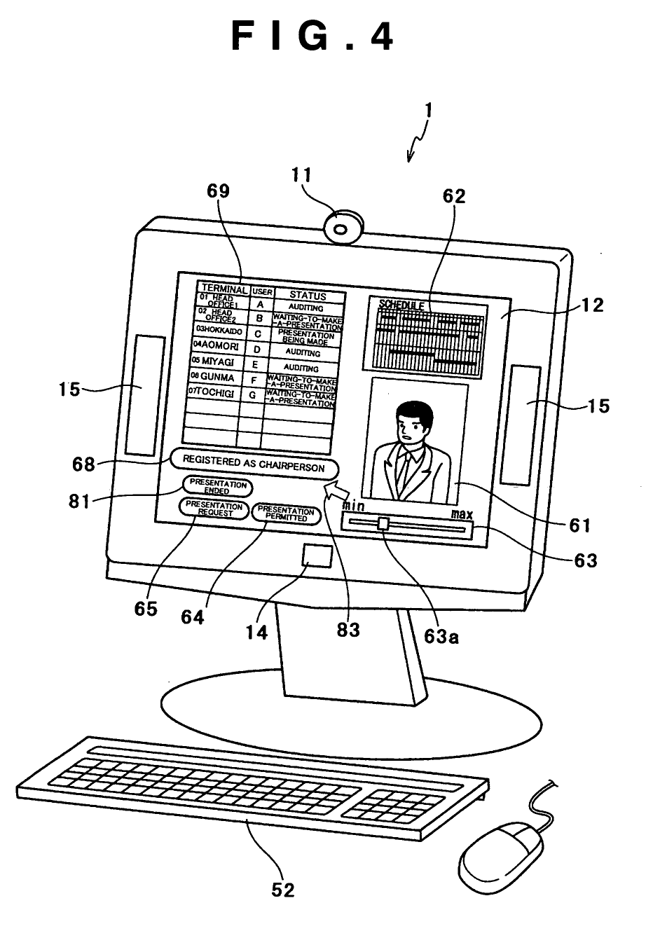

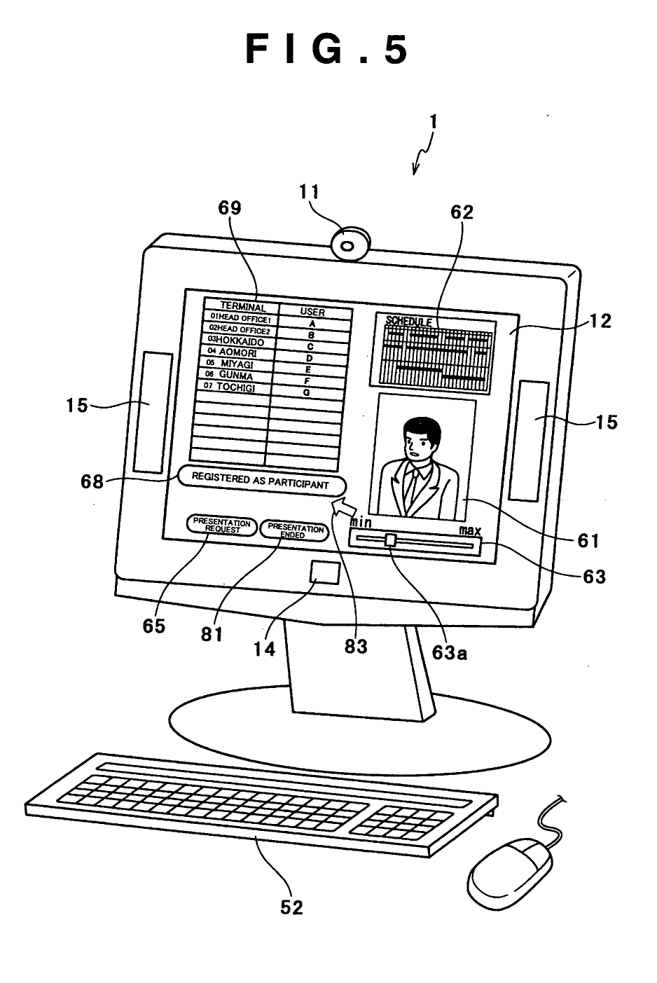

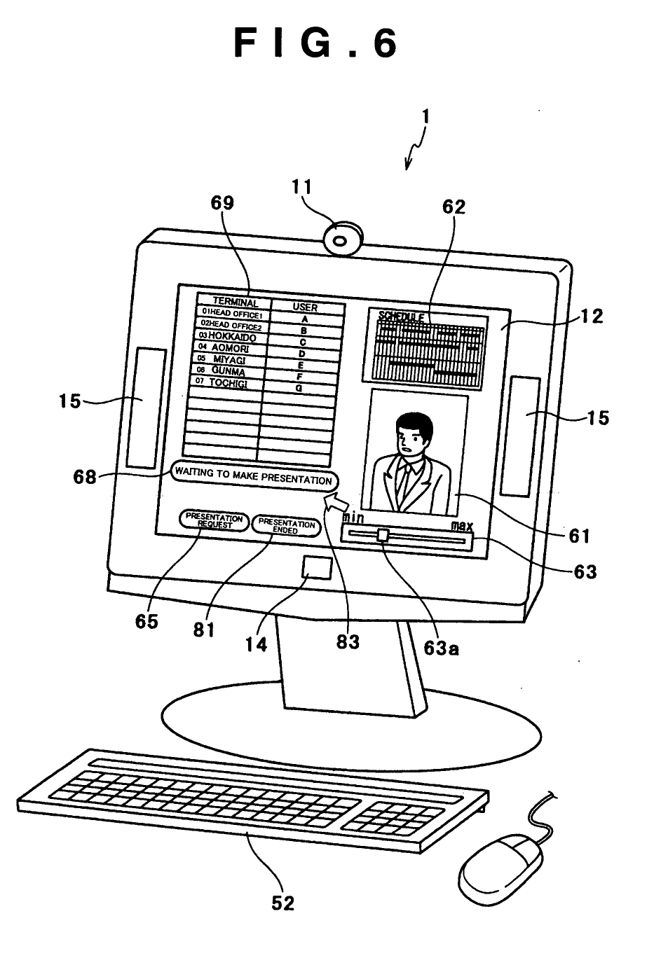

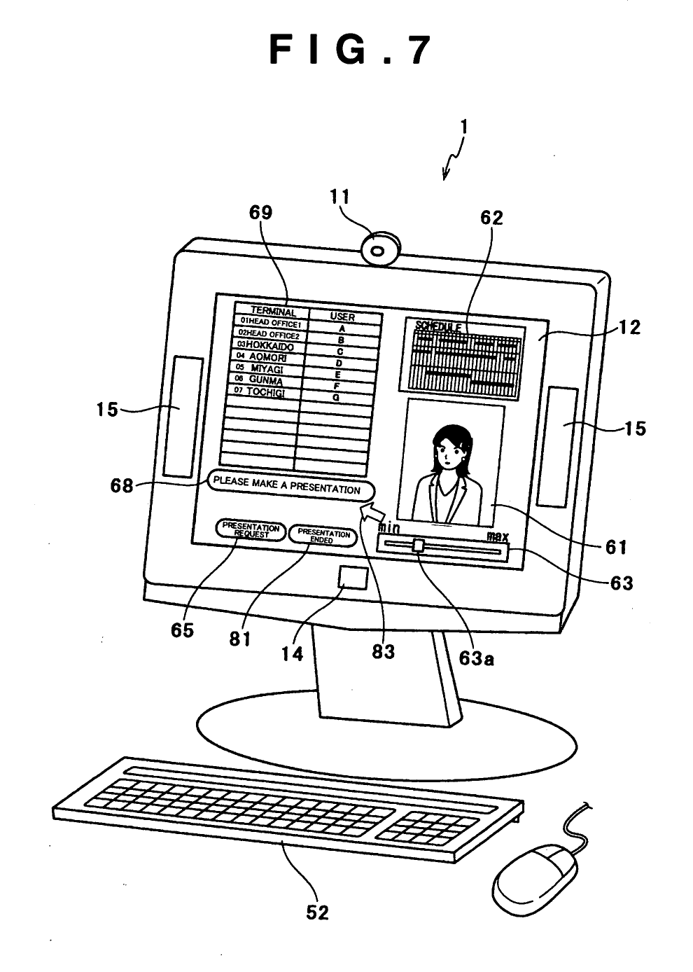

The teleconference terminal apparatus 1, which is configured as described above, displays various screens on a display section 12 before, after, or during a conference. For example, a registration screen shown in FIG. 3 is displayed before and after a conference. After setting to the chairperson terminal mode, a chairperson screen shown in FIG. 4 is displayed. Furthermore, after setting to the participant terminal mode, a presentation screen shown in FIG. 5, a waiting-to-make-a-presentation screen shown in FIG. 6, presentation-being-made screen shown in FIG. 7, or the like is displayed as a participant screen.

As shown in FIG. 3, the registration screen, which is displayed before and after a conference, has: a participant display section 61 which displays the participants and the chairperson who make presentations in the conference in motion; a source material display section 62 which displays a source material of data, schedule, and the like used in the conference; a participant information display section 69 which displays participant information; and a comment display section 68 which assists in a progress and operation of the conference. It should be noted that specific contents are not displayed on the participant display section 61, source material display section 62, and participant display section 69, but information on a prospective conference, such as a schedule for the next conference, may be displayed. Also, a text such as “please register” is displayed on the comment display section 68 so as to encourage the users to make a selection between the chairperson terminal mode or participant terminal mode.

Moreover, the registration screen displays a level adjuster 63, a chairperson selection button 66, a participant selection button 67, and a pointer 83 which can freely be moved on the screen by operating a mouse. The level adjuster 63 is for adjusting the level of a voice outputted from speakers 15, 15, and the level can be adjusted by holding a knob 63a using the pointer 83, and sliding the knob 63a in a lateral direction. The chairperson selection button 66 can be pressed using the pointer 83 to set the teleconference terminal apparatus 1 to the chairperson terminal mode. The participant selection button 67 can be pressed using the pointer 83 to set the teleconference terminal apparatus 1 to the participant terminal mode.

As shown in FIG. 4, the chairperson screen which is displayed in the chairperson terminal mode has the abovementioned participant display section 61, source material display section 62, participant information display section 69, comment display section 68, level adjuster 63, a presentation end button 81, a presentation request button 65, and a presentation permitting button 64. The participant display section 61 displays a participant who is allowed to make a presentation, or displays the chairperson in the cases other than the case where permission to make a presentation is provided. The source material display section 62 displays a schedule or the like which is used in a conference. The participant information display section 69 displays the participant information for the chairperson terminal mode. Specifically, the information on the terminals participating in the conference (number data, location data), the user information (name data), and the status information (status data) are displayed in the form of a list on the screen, on the basis of the data stored in the conference information management table shown in FIG. 2. The comment display section 68 displays text information such as “registered as chairperson”.

Further, the presentation end button 81 can be pressed using the pointer 83 to end the presentation of the chairperson or of a participant. The presentation request button 65 can be pressed using the pointer 83 to forcibly allow the chairperson to make a presentation even in the middle of the presentation of a participant. The presentation permitting button 64 can be pressed using the pointer 83 to allow a participant, who is waiting to make a presentation, to make a presentation. It should be noted that if a plurality of participants are waiting to make presentations, the pointer 83 is moved to the participant information display section 69 to specify a participant, before pressing the presentation permitting button 64.

As shown in FIG. 5 through FIG. 7, the participant screen, which is displayed in the participant terminal mode, has the abovementioned participant display section 61, source material display section 62, participant information display section 69, comment display section 68, level adjuster 63, presentation request button 65 which requests an apparatus 1 in the chairperson terminal mode a permission to make a presentation, and presentation end button 81 which notifies the apparatus 1 in the chairperson terminal mode of the end of a presentation. The participant display section 61 displays the participant information constituted with terminal information and user information, in the form of a list. On the presentation screen shown in FIG. 5, the comment display section 68 displays a text such as “registered as participant”. On the waiting-to-make-a-presentation screen shown in FIG. 6, the comment display section 68 displays a text such as “waiting to make presentation”. On the presentation-being-made screen shown in FIG. 7, the comment display section 68 displays a text such as “please make a presentation”.

(Operations of Teleconference System and Teleconference Terminal Apparatus 1)

Operations of the teleconference system and teleconference terminal apparatus 1 are described based on the above configuration.

A schedule of a conference is managed in the groupware server 4. When it is determined that a conference is conducted on predetermined time and date, a mail for notifying of the conference is transmitted from the groupware server 4 to the teleconference terminal apparatus 1 having the groupware client function or to other terminal apparatuses. A person who receives the notification of the conference sets an image-capturing device 11, microphone 14 and the like of the teleconference terminal apparatus 1 to an operating state, reads the information required in the conference by means of the web browser function 41 of the user information processing section 17 as shown in FIG. 3 or FIG. 4, causes the source material display section 62 to display the information, and thereby prepares for the conference. Then, by operating an operation section 52, the person reports to the groupware server 4 that preparation for the conference is completed.

(Initial Setting Processing)

In each teleconference terminal apparatus 1, the processing routines such as the initial setting routine shown in FIG. 8 and the information output processing routine shown in FIG. 9 are independently executed in parallel. Specifically, as shown in FIG. 8, when executing the initial setting routine, first of all the registration screen of FIG. 3 is displayed to encourage the participants of the conference to select whether to participate in the conference as a chairperson or as a participant (S1). Then, an input of the information on the individuals conducting the conference is received through an operation of the operation section 52 such as the keyboard or mouse, and the inputted information is transmitted to each of the teleconference terminal apparatus 1 (S2). It should be noted that the amount of data contained in the information on the individuals conducting the conference is extremely small compared to the data amount of the image signals and voice signals, and such information is not necessarily transmitted in real time. Therefore, the information on the individuals conducting the conference is transmitted to the communications network 2 via the low-speed data processing section 53 shown in FIG. 1.

Next, the pressing operations of the participant selection button 67 and the chairperson selection button 66 are monitored and the registration of either a participant or chairperson is received (S3). It should be noted that the pressing operation on the screen of the display section 12 is carried out by, for example, clicking the left mouse button after moving the pointer 83 on the icon of the participant selection button 67. Once the registration is performed through the pressing operation, it is determined whether the registration is performed as a chairperson or not (S4). If the registration is performed as a chairperson (S4, YES), subsequently it is determined whether there are teleconference terminal apparatuses 1 which are set to the chairperson terminal mode by the registration as a chairperson. (S5). If there are such teleconference terminal apparatuses 1 (S5, YES), the steps are executed again starting from S3, it is reported that the registration as a chairperson cannot be received, and registration as a participant can be made.

On the other hand, if there are no teleconference terminal apparatuses 1 which are set to the chairperson terminal mode by the registration as a chairperson (S5, NO), the chairperson registration screen shown in FIG. 4 is displayed. Specifically, by displaying a text such as “registered as chairperson” on the comment display section 68, it is reported that the chairperson terminal mode is set so that the participant can participate in the conference as a chairperson. Moreover, the participant information display section 69 displays the terminal information, user information, and status information as the information on the individuals conducting the conference, in the form of a list, so that the conference can be proceeded based on the status information and the like (S6).

Thereafter, the chairperson terminal mode is set (S7) and the chairperson procedure processing, which is described hereinafter, is executed (S8). Once this processing ends, it is determined that the conference ends, the setting of the chairperson terminal mode is canceled, and then the processing is started from S1, whereby a registration screen for the next teleconference is displayed.

Further, when the setting through the pressing operation is not for the chairperson registration in S4 (S4, NO), the participant registration screen shown in FIG. 5 is displayed. Specifically, by displaying a text such as “registered as participant” on the comment display section 68, it is reported that the participant terminal mode is set so that the participant can participate in the conference as a participant. Moreover, the participant information display section 69 displays the terminal information and user information as the information on the individuals conducting the conference, in the form of a list, so that the participant can be recognized (S10).

Thereafter, the participant terminal mode is set (S11) and the participant procedure processing, which is described hereinafter, is executed (S12). Once this processing ends, it is determined that the conference ends, the setting of the participant terminal mode is canceled (S13), and then the processing is started from S1, whereby a registration screen for the next teleconference is displayed.

(Information Output Processing)

When executing the information output processing routine which is executed in parallel with the initial setting routine, as shown in FIG. 9, first of all it is determined whether registration is completed as a chairperson or participant (setting of the chairperson terminal mode or the participant terminal mode) (A1). If the registration is not yet completed (A1, NO), this routine is ended to wait for completion of the registration. If the registration is completed (A1, YES), an image signal, which is data of a video of a participant or chairperson transmitted via the communications network 2, is loaded (A2) and displayed on the participant display section 61 of the display section 12. Specifically, the image signal which is received via the communications network 2 is decoded (decompressed) at the decoder section 25, stored temporarily in a reception frame memory 27, converted into an analog signal by a D/A converter 26, and then outputted to the display section 12. Then, the image signal is displayed on the participant display section 61 of the display section 12 (A3).

Next, a voice signal, which is data of a voice of a participant or chairperson transmitted via the communications network 2, is loaded (A4). The voice level which is set by the level adjuster 63 is loaded (A5), and a voice is outputted at this level. Specifically, after a voice signal, which is received via the communications network 2, is decoded (decompressed) at the decoder section 35 and temporarily stored in a reception frame memory 37, the voice signal is converted into an analog signal by a D/A converter 36 and then outputted to the speakers 15 (A6). Accordingly, once the image signal and voice signal are transmitted through a presentation of the chairperson or participant, an action based on the image signal is displayed on the participant display section 61 of other teleconference terminal apparatus 1, and at the same time a speech based on the voice signal is outputted as a voice from the speakers 15. Thereafter, whether the conference is ended or not is determined (A9). If the conference is not yet ended (A9, NO), the steps are executed again starting from A2, whereby display of images and output of voices are continued.

(Participant Procedure Processing)

Once the participant terminal mode is set in the initial setting processing, the participant procedure processing is executed. Specifically, as shown in FIG. 10, the participant procedure processing routine is executed to determine whether a presentation request is made through a pressing operation of the presentation request button 65 shown in FIG. 5 (B1). If a presentation request is not made (B1, NO), whether the conference is ended or not is determined (B14), and if the conference is ended (B14, YES), this routine is ended. On the other hand, if the conference is not ended (B14, NO), B1 is executed again.

If a presentation request is made (B1, YES), a presentation request signal is transmitted to an apparatus 1 which is set to the chairperson terminal mode (B2). Thereafter, whether the conference is ended or not is determined (B3). If the conference is ended (B3, YES), this routine is ended even if no presentation is made. On the other hand, if the conference is not yet ended (B3, NO), subsequently it is determined whether permission to make a presentation is granted by the apparatus 1 which is set to the chairperson terminal mode (B4). If the permission to make a presentation is not provided, (B4, NO), the waiting-to-make-a-presentation screen shown in FIG. 6 is displayed and the processing executed again starting from B3 to wait until the permission to make a presentation is provided.

On the other hand, if the permission to make a presentation is provided (B4, YES), the presentation screen shown in FIG. 7 is displayed, outputting of an image signal and a voice signal of an image in motion and a voice of the participant who is permitted to make a presentation is started (B7). It should be noted that the outputting the image signal and voice signal means an operation for transmitting these signals to the communications network 2 and an operation for displaying an image and outputting a voice based on these signals.

Specifically, as shown in FIG. 1, the transmission permission signal is outputted from the computing section 51 to the gates 71 and 72 of the image processing section 13 and the voice processing section 16 to enable passage of the image signal and the voice signal. Accordingly, in the image processing section 13, the image signal, which is obtained by capturing an image of a participant by means of the image-capturing device 11, is loaded into an A/D converter 21 to be converted into a digital signal, temporarily stored in the transmission frame memory 22, and thereafter outputted to the encoder section 24 of the image codec section 23 via the gate 71. The image signal is then compressed at a predetermined compression rate. Thereafter, the compressed image signal is outputted from the image processing section 13 to the interface section 54, and transmitted to other teleconference terminal apparatus 1 through the MCU 3 via the communications network 2 or directly transmitted to other teleconference terminal apparatus 1 via the communications network 2.

In the voice processing section 16, the voice signal, which is obtained by collecting voices of the participants by means of the microphone 14, is loaded into an A/D converter 31 to be converted into a digital signal, and temporarily stored in the transmission frame memory 32. The voice signal is then outputted from the transmission frame memory 32 to a voice codec section 33 via the gate 72 and compressed at a predetermined compression rate by the encoder section 34 of the voice codec section 33. Thereafter, the compressed voice signal is outputted from the voice processing section 16 to the interface section 54, and transmitted to other teleconference terminal apparatus 1 through the MCU 3 via the communications network 2 or directly transmitted to other teleconference terminal apparatus 1 via the communications network 2. Accordingly, as shown in FIG. 7, an action of the participant making a presentation is displayed on the participant display section 61 and the voice of this participant is outputted.

Next, it is determined whether a presentation end signal is received from the apparatus 1 set to the chairperson terminal mode (B8). If it is received (B8, YES), the presentation end signal is transmitted to the apparatus 1 set to the chairperson terminal mode, in order to report that the presentation is discontinued and ended (B11). On the other hand, if the presentation end signal is not received (B8, NO), whether the conference is ended or not is determined (B9). If the conference is ended (B9, YES), the presentation is forcibly discontinued even in the middle of the presentation, and the present routine is ended. On the other hand, if the conference is not ended (B9, NO), it is determined whether the presentation is ended by pressing the presentation end button 81 (B10). If the presentation is not ended (B10, NO), the processing is executed again starting from B8, and the presentation is continued until it is ended forcibly or on the participant's own judgment.

If the presentation is ended (B10, YES), the presentation end signal is transmitted to the apparatus 1 set to the chairperson terminal mode, in order to report that the presentation is ended (B11). Thereafter, outputting of the image signal and voice signal is stopped (B12), nothing is displayed on the participant display section 61, and the screen of the participant display section 61 is switched to an auditing screen on which the chairperson is displayed (B13). Then, whether the conference is ended or not is determined (B14), and if the conference is ended (B14, YES), the present routine is ended. On the other hand, if the conference is not ended (B14, NO), B1 is executed again.

(Chairperson Procedure Processing)

When the chairperson terminal mode is set in the initial setting processing described above, the chairperson procedure processing is executed. In other words, as shown in FIG. 11, the chairperson procedure processing routine is executed, and outputting of an image signal and voice signal of the chairperson is started (C1). Accordingly, an image of the chairperson is displayed in all of the teleconference terminal apparatuses 1. Thereafter, it is determined whether a presentation request signal is received from other apparatus 1 which is set to the participant terminal mode (C2). If the presentation request signal is not received (C2, NO), C2 is executed again to wait for the presentation request signal. It should be noted that the conference may be ended forcibly during this wait.

If the presentation request signal is received (C2, YES), the apparatus 1, which is the source terminal for transmission of the presentation request signal, is specified (C3), and the transmission source terminal is set to a waiting-to-make-a-presentation status, that is, the status information of the information on the individuals conducting the conference, which is displayed on the participant information display section 69, is rewritten to and displayed as the waiting-to-make-a-presentation status (C4). Thereafter, it is determined whether the next presentation request signal is received from other teleconference terminal apparatus 1 or not (C5). If received (C5, YES), the processing is executed again starting from C3, whereby the transmission source terminal is set to the waiting-to-make-a-presentation status.

On the other hand, if the presentation request signal is not received (C5, NO), whether the conference is ended or not is determined (C6). If the conference is ended (C6, YES), the present routine is ended. At this moment, all of the teleconference terminal apparatuses 1 are instructed to end the conference. On the other hand, if the conference is not ended (C6, NO), it is determined whether permission to make a presentation is provided (C7). If the permission to make a presentation is not provided (C7, NO), C5 is executed again. If the permission to make a presentation is provided (C7, YES), the presentation request signal is transmitted to the teleconference terminal apparatus 1 which is permitted to make a presentation (C8). Then, the status information corresponding to this teleconference terminal apparatus 1 is set to the presentation-being-made status (C9), the outputting of the image signal and voice signal is stopped (C10). Accordingly, in place of displaying an image of the chairperson and outputting the voice of the chairperson, display of an image and outputting of the voice of the participant making a presentation are performed by all of the teleconference terminal apparatuses 1.

Next, it is determined whether the presentation end signal is received (C11). If the presentation end signal is received (C11, YES), outputting of an image signal and voice signal is started, all of the teleconference terminal apparatuses 1 are switched to outputting of an image and voice of the chairperson (C17), and thereafter the processing is executed again starting from C5. On the other hand, if the presentation end signal is not received (C11, NO), it is determined whether a request of a presentation is made from the chairperson (C12). If such request is not made from the chairperson (C12, NO), the processing is executed again starting from C5. On the other hand, if the request of a presentation is made from the chairperson (C12, YES), the presentation end signal is transmitted to the apparatus 1 in the middle of its presentation to end the presentation (C13), and thereafter outputting of the image signal and voice signal of the chairperson is started (C14). Thereafter, whether the presentation is ended or not is determined (C15). If the presentation is not ended (C15, NO), C15 is executed again, whereby the presentation of the chairperson is continued. On the other hand, if the presentation is ended (C15, YES), outputting of the image signal and voice signal is stopped (C16) and the present routine is ended.

(Effect of the Embodiment)

As described above, the teleconference system of the present embodiment has, as shown in FIG. 1: the plurality of teleconference terminal apparatuses 1 which transmit and receive image signals and voice signals to conduct a teleconference by displaying images and outputting voices; the communications network 2 which connects the teleconference terminal apparatuses 1 so that data can be communicated; and the mode setting means (the computing section 51, the initial setting routine shown in FIG. 8, and the like) for setting any apparatus of the teleconference terminal apparatuses 1 to the chairperson terminal mode for managing a teleconference. The teleconference terminal apparatuses 1 comprise the transmission control means (the computing section 51, the participant procedure processing routine shown in FIG. 10, the chairperson procedure processing routine shown in FIG. 11, and the like) for transmitting image signals and voice signals, only when permitted by the apparatus 1 which is set to the chairperson terminal mode. It should be noted that the above mode setting means may be built into the teleconference terminal apparatus 1 as in the present embodiment, or may be a terminal apparatus which is provided separately from the teleconference terminal apparatus 1.

According to the above configuration, the transmission control means, which is provided in the teleconference terminal apparatus 1, transmits image signals and voice signals only when permitted by the apparatus 1 which is set to the chairperson terminal mode, whereby a teleconference is carried out among all of the participant terminal apparatuses 1 by using these image signals and the like. Therefore, the data amount in the communications network 2 can be reduced, the communications network 2 connecting the teleconference terminal apparatuses 1 so that the data can be communicated. Accordingly, compared to the prior art where image signals having the same data amount are transmitted from all of the teleconference terminal apparatuses 1 to the communications network 2, in the present invention the increase of the traffic in the communications network 2 can be prevented, and at the same time the contents of a notable participant making a presentation can be checked on the big screen and at a good quality.

Moreover, the teleconference method of the present embodiment is a teleconference communication method for conducting a teleconference through display of images and outputting of voices by means of the plurality of teleconference terminal apparatuses 1 transmitting and receiving image signals and voice signals via the communications network 2, wherein one of the teleconference terminal apparatuses 1 is set to the chairperson terminal mode, and only the teleconference terminal apparatus 1, which has permission of the apparatus 1 set to the chairperson terminal mode, can transmit the image signals and voice signals.

According to the above configuration, only the teleconference terminal apparatus 1 which has permission of the apparatus 1 set to the chairperson terminal mode can transmit an image signal, whereby a teleconference can be conducted among all of the teleconference terminal apparatuses 1 using this image signal and the like, thus the data amount in the communications network 2 can be reduced, the communications network 2 connecting the teleconference terminal apparatuses 1 so that the data can be communicated. Therefore, compared to the prior art where image signals having the same data amount are transmitted from all of the teleconference terminal apparatuses 1 to the communications network 2, in the present invention the increase of the traffic in the communications network 2 can be prevented, and at the same time the contents of a notable participant making a presentation can be checked on the big screen and at a good quality.

Moreover, the teleconference terminal apparatus 1 of the present embodiment is a teleconference terminal apparatus 1 for conducting a teleconference through display of images and outputting of voices by transmitting image signals and voice signals via the communications network 2, the teleconference terminal apparatus 1 comprising: the mode setting means for setting the teleconference terminal apparatus 1 to either a chairperson terminal mode or a participant terminal mode (computing section 51, the initial setting routine shown in FIG. 8, and the like); the transmission switching means capable of switching between a transmission of image signals and voice signals and a stoppage of transmission of image signals and voice signals (gates 71, 72, and the like); the presentation requesting means for requesting the teleconference terminal apparatus 1, which is set to the chairperson terminal mode, to make a presentation by transmitting the image signals and the voice signals during a teleconference (computing section 51, the participant procedure processing routine shown in FIG. 10, and the like); the presentation request recognition means for recognizing the apparatus 1 in the participant terminal mode, which requests for permission to make a presentation (computing section 51, chairperson procedure processing routine shown in FIG. 11, and the like); and the switching control means for controlling the transmission switching means of the apparatus 1 in the participant terminal mode, the apparatus being recognized by the presentation request recognition means, so as to allow this apparatus 1 to make a presentation.

According to the above configuration, one teleconference terminal apparatus 1 can be switched between the chairperson terminal mode or the participant terminal mode, thus setting of the chairperson and the like can be performed easily. Further, only the teleconference terminal apparatus 1 in the participant terminal mode, which has permission of the apparatus 1 set to the chairperson terminal mode, can transmit an image signal and the like, whereby a teleconference can be conducted among all of the teleconference terminal apparatuses 1 using this image signal and the like, thus the data amount in the communications network 2 can be reduced. Therefore, compared to the prior art where image signals having the same data amount are transmitted from all of the teleconference terminal apparatuses 1 to the communications network 2, in the present invention the increase of the traffic in the communications network 2 can be prevented, and at the same time the contents of a notable participant making a presentation can be checked on the big screen and at a good quality.

The above describes the embodiments of the present invention. However, the above embodiments are merely specific examples, thus the present invention is not limited to these examples and the specific configurations and the like can be modified accordingly. It should be noted that the above operations and effects described in the embodiments are merely the most preferred operations and effects which are produced from the present invention. Therefore, the operations and effects produced in the present invention are not limited to the descriptions of the embodiments of the present invention.

What is claimed is:

1. A teleconference system, comprising:
a plurality of teleconference terminal apparatuses which conduct a teleconference with display of images and outputting of voices by transmitting and receiving image signals and voice signals;
a communications network which connects the teleconference terminal apparatuses to communicate data; and
a chairperson terminal mode setting unit for arbitrarily setting any apparatus of the teleconference terminal apparatuses to a chairperson terminal mode for managing a teleconference;
wherein each of the teleconference terminal apparatuses has transmission control unit for transmitting the image signals and voice signals only when permitted by an apparatus which is set to the chairperson terminal mode.

2. The teleconference system according to claim 1, wherein each of the teleconference terminal apparatuses comprises:
an image-capturing device which generates the image signals by capturing an image;
an image output processing unit which converts the image signal to a signal mode corresponding to the communications network and outputs the converted signal;
a microphone which performs detection of a voice along with the image capturing, and thereby generates a voice signal corresponding to the level of the voice;
a voice output processing unit which converts the voice signal to a signal mode corresponding to the communications network and outputs the converted signal;
an image output processing control unit which increases or reduces the amount of data of the image signal outputted from the image output processing unit, on the basis of the level of the voice signal; and
a display which displays information related to the image signal, on a screen.

3. The teleconference system according to claim 1, wherein, in the display, a chairperson screen, which is displayed in a chairperson terminal mode, displays at least a participant display section, a presentation end button for ending a presentation of the chairperson and other participant, a presentation request button for forcibly causing the chairperson to make a presentation, and a presentation permitting button for permitting a participant, who waits to make a presentation, to make a presentation.

4. The teleconference system according to claim 2, wherein
the image output processing unit comprises: an image signal transmission frame memory; an image codec unit which compresses the image signal; and, between the image signal transmission frame memory and the image codec unit, an image signal transmission switching unit for switching between permission of passage and prohibition of passage of the image signal in response to a switch signal from a transmission signal switching control unit, and wherein
the voice output processing unit which comprises: a voice signal transmission frame memory; a voice codec unit which compresses the voice signal; and, between the voice signal transmission frame memory and the video codec unit, a voice signal transmission switching unit for switching between permission of passage and prohibition of passage of the voice signal in response to a switch signal from the transmission signal switching control unit.

5. A teleconference terminal apparatus for conducting a teleconference through display of images and outputting of voices by transmitting and receiving image signals and voice signals via a communications network, comprising:
a mode setting unit for setting the teleconference terminal apparatus to either a chairperson terminal mode or a participant terminal mode;
a transmission switching unit for switching between a transmission of the image signals and the voice signals and a stoppage of transmission of the image signals and the voice signals;
a presentation requesting unit for requesting the teleconference terminal apparatus, which is set to the chairperson terminal mode, to make a presentation by transmitting the image signals and the voice signals;
a presentation request recognition unit for recognizing the apparatus in the participant terminal mode requesting the presentation; and
a switching control unit for controlling the transmission switching unit of the apparatus in the participant terminal mode, the apparatus being recognized by the presentation request recognition unit, so as to allow the apparatus to make a presentation.

6. The teleconference terminal apparatus according to claim 5, comprising:
an image-capturing device which generates the image signals by capturing an image;
an image output processing unit which converts the image signal to a signal mode corresponding to the communications network and outputs the converted signal;
a microphone which performs detection of a voice along with the image capturing, and thereby generates a voice signal corresponding to the level of the voice;
a voice output processing unit which converts the voice signal to a signal mode corresponding to the communications network and outputs the converted signal;
an image output processing control unit which increases or reduces the amount of data of the image signal outputted from the image output processing unit, on the basis of the level of the voice signal; and
a display which displays information related to the image signal, on a screen.

7. The teleconference terminal apparatus according to claim 6, wherein
the image output processing unit comprises: an image signal transmission frame memory; an image codec unit which compresses the image signal; and, between the image signal transmission frame memory and the image codec unit, an image signal transmission switching unit, and wherein
the voice output processing unit which comprises: a voice signal transmission frame memory; a voice codec unit which compresses the voice signal; and, between the voice signal transmission frame memory and the voice codec unit, the voice signal transmission switching unit.

8. A teleconference communication method for conducting a teleconference with display of images and outputting of voices by a plurality of teleconference terminal apparatuses transmitting and receiving image signals and voice signals via a communications network, wherein
one of the teleconference terminal apparatuses is set to a chairperson terminal mode, and only the teleconference terminal apparatus, which has permission from the apparatus in the chairperson terminal mode, can transmit the image signals and voice signals.
